(19) United States
(12) Patent Application Publication
(10) Pub. No.: US 2019/0289278 A1
(43) Pub. Date: Sep. 19, 2019

(54) THREE-DIMENSIONAL SENSING MODULE AND COMPUTING DEVICE USING SAME

(71) Applicant: HON HAI PRECISION INDUSTRY CO., LTD., New Taipei (TW)

(72) Inventor: CHEN-KUANG YEH, New Taipei (TW)

(21) Appl. No.: 16/027,328

(22) Filed: Jul. 4, 2018

(30) Foreign Application Priority Data
Mar. 13, 2018 (CN) 201810206427.5

(51) Int. Cl. H04N 13/204; G06T 17/00; G06K 9/20; G06K 9/00; H04N 13/271

(52) U.S. Cl. CPC H04N 13/204; G06T 17/00; H04N 13/271; G06K 9/00201; G06K 9/2018

(57) ABSTRACT

A 3D sensing module for a computing device includes a frame and a depth sensor. The module is able to detect different depths and colors of a target object. The frame includes a first side portion, a second side portion, and a cross portion. The first side portion has a first opening and the second side portion has a second opening. The depth sensor is mounted on the frame, and the depth sensor includes first and second depth cameras. The first depth camera is received in the first opening and the second depth camera is received in the second opening. The first and second depth cameras can be optically aligned before being mounted together inside the housing of the computing device to ensure a precise and durable mounting.

### FIELD

The present disclosure relates to three-dimensional (3D) sensing by optical means.

### BACKGROUND

A computing device, such as a smart phone, with facial recognition function includes a housing, a depth sensor, and a color camera. The depth sensor and the color camera are mounted inside the housing and at the top front of the computing device to facilitate face recognition when a user looks at the computing device. The depth sensor captures data as to depth of the user's face, and the color camera is configured to capture data as to color of the user's face. The depth sensor includes two depth cameras. The depth cameras and the color camera need to be optically aligned inside the housing. However, optical alignment of the depth cameras and the color camera is often difficult. Additionally, the depth cameras and the color camera may become misaligned due to handling and other everyday forces applied to the computing device.

Accordingly, there is room for improvement in the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1A is a top perspective view of an embodiment of a 3D sensing module.

FIG. 1B is a bottom perspective view of the 3D sensing module of FIG. 1A.

FIG. 2 is a schematic front view of an embodiment of a computing device including the 3D sensing module of FIG. 1A.

FIG. 3A is a top exploded perspective view of the 3D sensing module of FIG. 1A.

FIG. 3B is a bottom exploded perspective view of the 3D sensing module of FIG. 1A.

FIGS. 4A-4C are perspective views of steps of assembly of the 3D sensing module of FIG. 1A.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

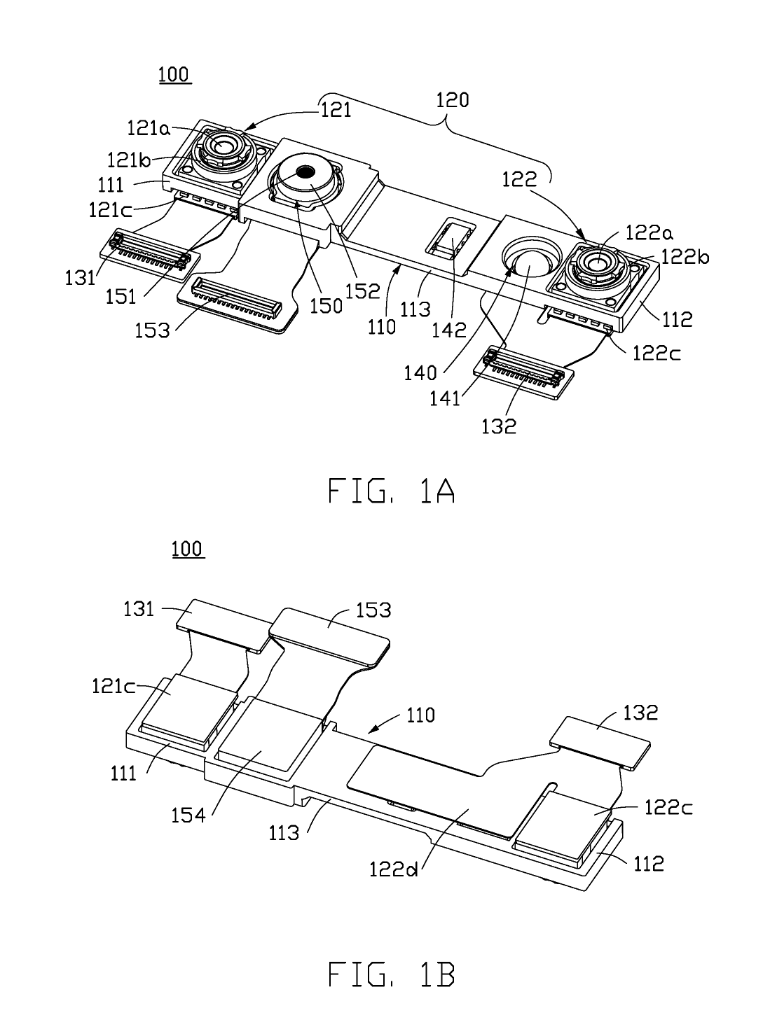

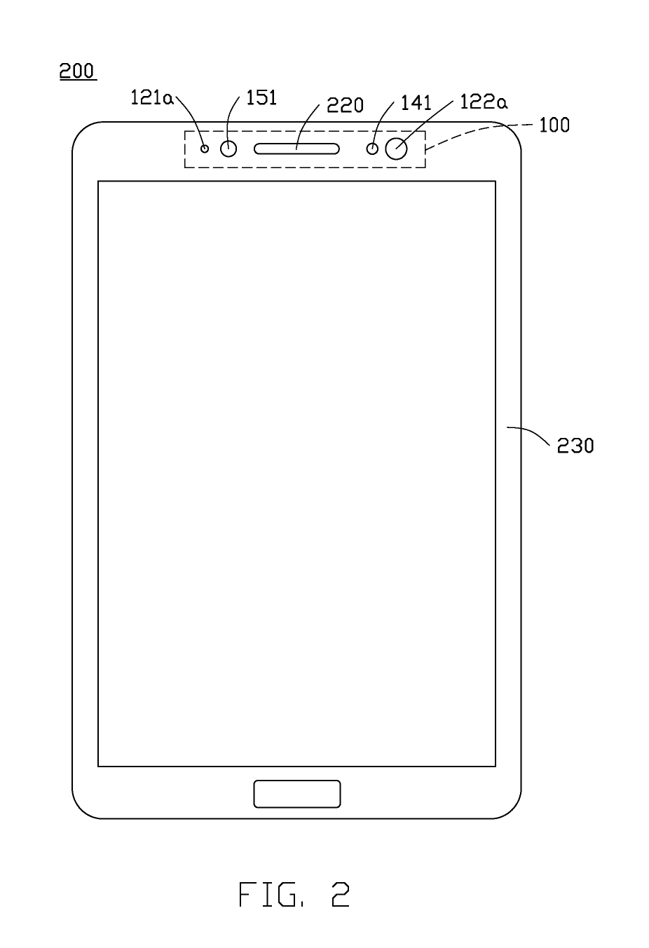

FIGS. 1A-2 show a computing device 200 which includes a housing 230, a speaker 220, and a 3D sensing module 100. The computing device 200 may include more or less components than as described. The computing device 200 may be a smart phone, tablet, laptop, or other device. In the present embodiment, the computing device 200 is a smart phone. The 3D sensing module 100, adjacent to the speaker 220, is mounted inside the housing 230 for face recognition of a user looking at the computing device 200.

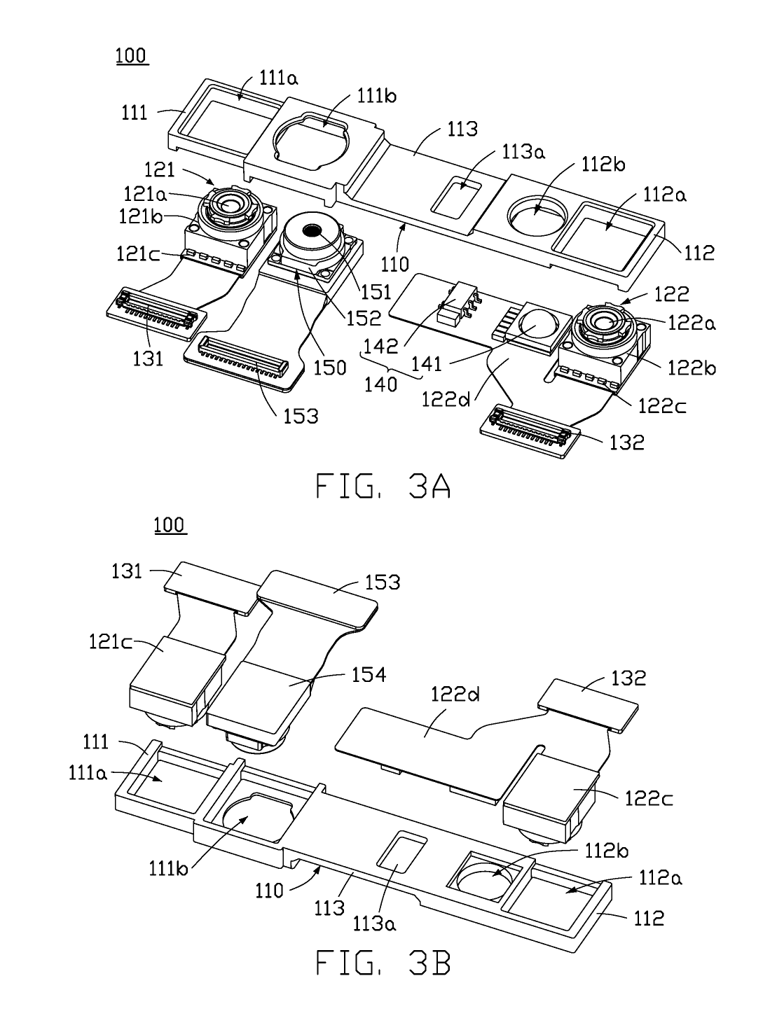

With reference to FIGS. 3A-3B, the 3D sensing module 100 includes a frame 110, a depth sensor 120, and a color camera unit 150. The depth sensor 120 and the color camera unit 150 are secured to the frame 110 as a modular structure.

The frame 110 is made of a rigid material, such as metal or hard plastic, that is resistant to deformation. The frame 110 includes a first side portion 111, a second side portion 112, and a cross portion 113. The cross portion 113 is connected between the first side portion 111 and the second side portion 112. The first side portion 111, the cross portion 113, and the second side portion 112 are disposed in a straight line. The first side portion 111 has a first depth camera receiving opening 111a and a color camera receiving opening 111b. The second side portion 112 has a second depth camera receiving opening 112a and a light emitter receiving opening 112b. The cross portion 113 has a light controller receiving opening 113a. The cross portion 113 is recessed for receiving the speaker 220 or other components inside the housing 230.

The depth sensor 120 captures data about the depth of the user's face. The depth sensor 120 is mounted on the frame 110. The depth sensor 120 includes a first depth camera unit 121, a second depth camera unit 122, and a light emitting unit 140.

The first depth camera unit 121 is mounted on the first side portion 111 of the frame 110. The first depth camera unit 121 includes a first camera mount 121b, a first depth camera 121a, a first circuit board 121c, and a first connector 131. The first camera mount 121b is received in the first depth camera receiving opening 111a of the first side portion 111. The first depth camera 121a is secured to the first camera mount 121b. The first depth camera 121a is an infrared time-of-flight depth camera. The first circuit board 121c is located under the first side portion 111. The first circuit board 121c connects the first depth camera 121a to the first connector 131. The first connector 131 is located outside of the first side portion 111. The first depth camera 121a is electrically connected to components inside the housing 230, through the first connector 131.

The second depth camera unit 122 is mounted on the second side portion 112 of the frame 110. The second depth camera unit 122 includes a second camera mount 122b, a second depth camera 122a, a second circuit board 122c, and a second connector 132. The second camera mount 122b is received in the second depth camera receiving opening 112a of the second side portion 112. The second depth camera 122a is secured to the second camera mount 122b. The second depth camera 122a is an infrared time-of-flight depth camera. The second circuit board 122c is located under the second side portion 112 and the cross portion 113. The second circuit board 122c connects the second depth camera 122a to the second connector 132. The second connector 132 is located outside of the second side portion 112. The second depth camera 122a is electrically connected to components inside the housing 230, through the second connector 132.

The light emitting unit 140 includes a light emitter 141 and a light controller 142. The light emitter 141 and the light controller 142 are electrically connected to a side portion 122d of the second circuit board 122c. The light emitter 141 is received in the light emitter receiving opening 112b of the second side portion 112 of the frame 110. The light controller 142 is received in the light controller receiving opening 113a of the cross portion 113 of the frame 110. The light emitter 151 is an infrared LED device. The light controller 142 is configured to control the light emitter 141.

The color camera unit 150 is configured to capture data as to color of the user's face. The color camera unit 150 is mounted on the first side portion 111 of the frame 110. The color camera unit 150 includes a third camera mount 152, a color camera 151, a third circuit board 154, and a third connector 153. The third camera mount 152 is received in the color camera receiving opening 111b of the first side portion 111. The color camera 151 is secured to the third camera mount 152. The color camera 151 is an RGB camera. The third circuit board 154 is located under the first side portion 111. The third circuit board 154 connects the color camera 151 to the third connector 153. The third connector 153 is located outside of the first side portion 111. The color camera 151 is electrically connected to components inside the housing 230, through the third connector 153.

The first depth camera 121a, the color camera 151, the light emitter 141, and the second depth camera 122a are disposed in a straight line. The first depth camera 121a, the second depth camera 122a, the color camera 151, and the light emitter 141 can be optically aligned after being mounted on the frame 110 and before being mounted inside the housing 230. Optical alignment of the first depth camera 121a, the second depth camera 122a, the color camera 151, and the light emitter 141 can thus be done outside of the housing 230, and more accurately. Additionally, the frame 110 holds the first depth camera 121a, the second depth camera 122a, the color camera 151, and the light emitter 141 to avoid displacement/misalignment.

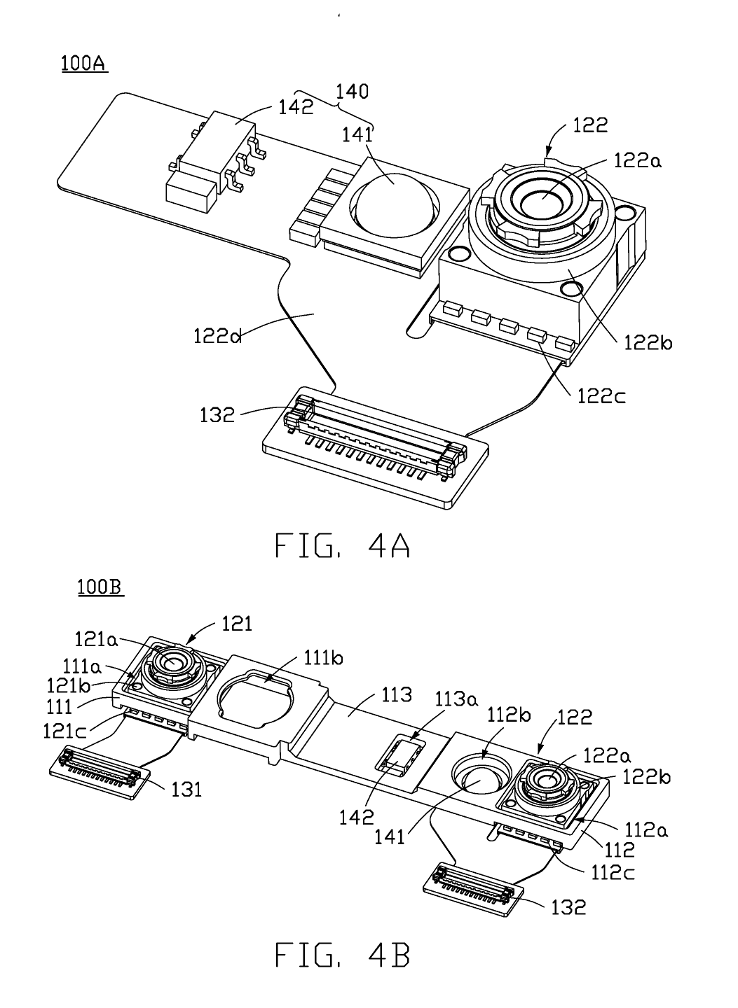

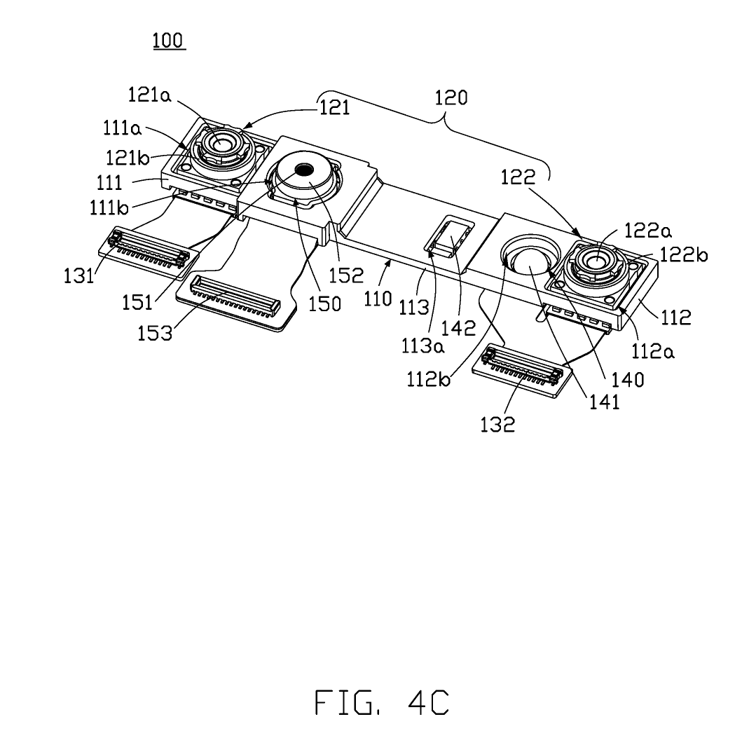

FIGS. 4A-4C show assembly steps of the 3D sensing module 100.

In FIG. 4A, the light emitter 141 and the light controller 142 of the light emitting unit 140 are coupled to the second circuit board 122c of the second depth camera unit 122, to produce a first semi-finished product 100A.

In FIG. 4B, the first semi-finished product 100A and the first depth camera unit 121 are assembled on the frame 110 such that the first camera mount 121b is received in the first depth camera receiving opening 111a. The second camera mount 122b is received in the second depth camera receiving opening 112a, the infrared emitter 141 is received in the light emitter receiving opening 112b, and the light controller 142 is received in the light controller receiving opening 113a. The first depth camera 121a, the second depth camera 122a, and the infrared emitter 141 are then optically aligned, and then adhesive is used to secure the first camera mount 121b and the second camera mount 122b to the frame 110, to produce a second semi-finished product 100B.

In FIG. 4C, the color camera unit 150 is assembled on the second semi-finished product 100B such that the third camera mount 152 is received in the color camera receiving opening 111b. The color camera 151 is then optically aligned, and then adhesive is used to secure the third camera mount 152 to the frame 110, thereby completing the assembly.

The embodiments shown and described above are only examples. Many details are often found in this field of art thus many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A 3D sensing module comprising:
a frame comprising:
a first side portion having a first depth camera receiving opening;
a second side portion having a second depth camera receiving opening; and
a cross portion; and
a depth sensor mounted on the frame, and the depth sensor comprising:
a first depth camera unit mounted on the first side portion of the frame, and the first depth camera unit comprising:
a first camera mount received in the first depth camera receiving opening of the first side portion; and
a first depth camera secured to the first camera mount; and
a second depth camera unit mounted on the second side portion of the frame, and the second depth camera unit comprising:
a second camera mount received in the second depth camera receiving opening of the second side portion; and
a second depth camera secured to the second camera mount.

2. The 3D sensing module of claim 1, wherein the first side portion, the cross portion, and the second side portion are disposed in a straight line.

3. The 3D sensing module of claim 2, wherein the cross portion is recessed.

4. The 3D sensing module of claim 1, wherein the first and second depth cameras are infrared time-of-flight depth cameras.

5. The 3D sensing module of claim 1, further comprising a color camera unit mounted on the first side portion of the frame;
wherein the first side portion has a color camera receiving opening; and
wherein the color camera unit comprises:
a third camera mount received in the color camera receiving opening of the first side portion; and
a color camera secured to the third camera mount.

6. The 3D sensing module of claim 5, wherein the color camera is an RGB camera.

7. The 3D sensing module of claim 5,
wherein the second side portion has a light emitter receiving opening; and
wherein the depth sensor comprises a light emitting unit, and the light emitting unit comprises a light emitter received in the light emitter receiving opening of the second side portion.

8. The 3D sensing module of claim 7,
wherein the cross portion has a light controller receiving opening; and
wherein the light emitting unit comprises a light controller received in the light controller receiving opening of the cross portion.

9. The 3D sensing module of claim 7,
wherein the first depth camera unit comprises a first circuit board connecting the first depth camera to a first connector;
wherein the second depth camera unit comprises a second circuit board connecting the second depth camera to a second connector;
wherein the color camera unit comprises a third circuit board connecting the color camera to a third connector; and
wherein the light emitter of the light emitting unit is connected to the second circuit board.

10. The 3D sensing module of claim 8,
wherein the first depth camera unit comprises a first circuit board connecting the first depth camera to a first connector;
wherein the second depth camera unit comprises a second circuit board connecting the second depth camera to a second connector;
wherein the color camera unit comprises a third circuit board connecting the color camera to a third connector; and
wherein the light emitter and the light controller of the light emitting unit are connected to the second circuit board.

11. A computing device comprising:
a housing; and
a 3D sensing module mounted inside the housing, and the 3D sensing module comprising:
a frame comprising:
a first side portion having a first depth camera receiving opening;
a second side portion having a second depth camera receiving opening; and
a cross portion; and
a depth sensor mounted on the frame, and the depth sensor comprising:
a first depth camera unit mounted on the first side portion of the frame, and the first depth camera unit comprising:
a first camera mount received in the first depth camera receiving opening of the first side portion; and
a first depth camera secured to the first camera mount; and
a second depth camera unit mounted on the second side portion of the frame, and the second depth camera unit comprising:
a second camera mount received in the second depth camera receiving opening of the second side portion; and
a second depth camera secured to the second camera mount.

12. The computing device of claim 11, wherein the first side portion, the cross portion, and the second side portion are disposed in a straight line.

13. The computing device of claim 12, wherein the cross portion is recessed.

14. The computing device of claim 11, wherein the first and second depth cameras are infrared time-of-flight depth cameras.

15. The computing device of claim 11,
wherein the first side portion has a color camera receiving opening; and
wherein the 3D sensing module comprises a color camera unit mounted on the first side portion, and the color camera unit comprises:
a third camera mount received in the color camera receiving opening of the first side portion; and
a color camera secured to the third camera mount.

16. The computing device of claim 15, wherein the color camera is an RGB camera.

17. The computing device of claim 15,
wherein the second side portion has a light emitter receiving opening; and
wherein the depth sensor comprises a light emitting unit, and the light emitting unit comprises a light emitter received in the light emitter receiving opening of the second side portion.

18. The computing device of claim 17,
wherein the cross portion has a light controller receiving opening; and
wherein the light emitting unit comprises a light controller received in the light controller receiving opening of the cross portion.

19. The computing device of claim 17,
wherein the first depth camera unit comprises a first circuit board connecting the first depth camera to a first connector;
wherein the second depth camera unit comprises a second circuit board connecting the second depth camera to a second connector;
wherein the color camera unit comprises a third circuit board connecting the color camera to a third connector; and
wherein the light emitter of the light emitting unit is connected to the second circuit board.

20. The computing device of claim 18,
wherein the first depth camera unit comprises a first circuit board connecting the first depth camera to a first connector;
wherein the second depth camera unit comprises a second circuit board connecting the second depth camera to a second connector;
wherein the color camera unit comprises a third circuit board connecting the color camera to a third connector; and
wherein the light emitter and the light controller of the light emitting unit are connected to the second circuit board.
